(19) United States
(12) Patent Application Publication
(10) Pub. No.: US 2015/0311502 A1
(43) Pub. Date: Oct. 29, 2015

(54) HYDROGEN-STORAGE ALLOY PARTICLES

(71) Applicant: TOYOTA JIDOSHA KABUSHIKI KAISHA, Toyota-shi (JP)

(72) Inventor: Tomoya MATSUNAGA, Susono-shi (JP)

(21) Appl. No.: 14/663,509

(22) Filed: Mar. 20, 2015

(30) Foreign Application Priority Data
Apr. 24, 2014 (JP) 2014-090070

(51) Int. Cl. H01M 4/24; H01M 4/26; H01M 4/48

(52) U.S. Cl. CPC H01M 4/242; H01M 4/48; H01M 4/26

(57) ABSTRACT

Novel hydrogen storage alloy particles which include vanadium which can reduce dissolution of vanadium to an alkali aqueous solution over a plurality of charging and discharging cycles when used for a negative electrode of an alkali storage battery are provided. Hydrogen storage alloy particles which contain titanium and vanadium as main components and which have an oxide layer which contains titanium oxide on their surface, the oxide layer having a thickness of 6.2 nm or more, are provided.

### TECHNICAL FIELD

The present invention relates to novel hydrogen storage alloy particles.

### BACKGROUND ART

A hydrogen storage alloy is generally an alloy which can hold hydrogen by intrusion of hydrogen into the crystal structure of the alloy, by substitution of atoms which form the crystal and hydrogen, etc. In particular, hydrogen storage alloy particles which contain vanadium are high in hydrogen storage ability and, for example, are used as negative electrode active components in negative electrodes of alkali storage batteries.

The above “alkali storage battery” is generally a secondary battery which uses an electrolyte constituted by a potassium hydroxide aqueous solution or other alkali aqueous solution. An alkali storage battery has a higher electromotive force compared with a lead-acid battery etc., is excellent in low temperature characteristics, is long in life, and has other advantages and is used for an automobile battery etc.

However, when using a negative electrode which contains hydrogen storage alloy particles which contain vanadium as the negative electrode active component for an alkali storage battery, at the time of charging and discharging, the vanadium sometimes dissolves out into the alkali aqueous solution and the battery performance falls. For this reason, attempts have been made to reduce the dissolution of vanadium.

For example, PLT 1 describes using an alkali storage battery which uses hydrogen storage alloy particles which contain vanadium as a main component in a negative electrode characterized by causing discharge so that a discharge cut-off voltage at the time of at least the first cycle of discharge becomes 1.05V or more.

### CITATIONS LIST

### Patent Literature

PLT 1: Japanese Patent Publication No. 2003-017116

### SUMMARY OF INVENTION

### Technical Problem

However, it was learned that when using conventional hydrogen storage alloy particles which contain vanadium in a negative electrode of an alkali storage battery, it is difficult to reduce the dissolution of vanadium into the alkali aqueous solution over a plurality of charging and discharging cycles.

The present invention has as its object the provision of novel hydrogen storage alloy particles which contain vanadium which can reduce the dissolution of vanadium in an alkali aqueous solution over a plurality of charging and discharging cycles at the time of use in a negative electrode of an alkali storage battery.

### Solution to Problem

The present invention solves the above problem by, for example, the following embodiments.

<1> Hydrogen storage alloy particles which contain titanium and vanadium as main components and which have an oxide layer on their surface, said oxide layer containing titanium oxide and having a thickness of 6.2 nm or more.
<2> A negative electrode which contains a negative electrode active component layer which includes hydrogen storage alloy particles according to <1> on a collector.
<3> An alkali storage battery which has a negative electrode according to <2>.
<4> The alkali storage battery according to <3> wherein a discharge cut-off voltage is 1.0V or more.
<5> A method of production of hydrogen storage alloy particles comprising bringing hydrogen storage alloy particles which contain titanium and vanadium as main components into contact with an alkali aqueous solution to make at least part of the vanadium dissolve out from the surface of the hydrogen storage alloy particles, then making the titanium which remains at the surface of the hydrogen storage alloy particles oxidize.
<6> A method of production of a negative electrode comprising forming a negative electrode active component layer which includes hydrogen storage alloy particles which contain titanium and vanadium as main components, bringing the negative electrode active component layer into contact with an alkali aqueous solution to make at least part of the vanadium dissolve out from the surface of the hydrogen storage alloy particles, then making the titanium which remains at the surface of the hydrogen storage alloy particles oxidize.

### Advantageous Effects of Invention

Novel hydrogen storage alloy particles which contain vanadium which can reduce the dissolution of vanadium in an alkali aqueous solution over a plurality of charging and discharging cycles at the time of use in a negative electrode of an alkali storage battery are provided.

### BRIEF DESCRIPTION OF DRAWINGS

FIG. 1 are schematic views which show cross sections of hydrogen storage alloy particles which contain titanium and vanadium as main components (FIG. 1a), hydrogen storage alloy particles which are brought into contact with an alkali aqueous solution (FIG. 1b), and hydrogen storage alloy particles of the present invention which have an oxide layer which contains titanium oxide at their surfaces (FIG. 1c).

FIG. 2 shows the results of analysis of the surface composition by energy dispersive X-ray spectroscopy (EDX) for hydrogen storage alloy particles of a negative electrode which was prepared based on the Example.

FIG. 3 shows the results of analysis of the surface composition by energy dispersive X-ray spectroscopy (EDX) for hydrogen storage alloy particles of a negative electrode which was prepared based on Comparative Example 1.

FIG. 4 shows the results of analysis of the surface composition by X-ray photoelectron spectroscopy (XPS) for hydrogen storage alloy particles of a negative electrode which was prepared based on the Example.

FIG. 5 shows the results of analysis of the surface composition by X-ray photoelectron spectroscopy (XPS) for hydrogen storage alloy particles of a negative electrode which was prepared based on Comparative Example 1.

### DESCRIPTION OF EMBODIMENTS

Hydrogen Storage Alloy Particles

The hydrogen storage alloy particles of the present invention contains titanium and vanadium as main components and has an oxide layer which contains titanium oxide at their surfaces. This oxide layer has a thickness of 6.2 nm or more.

Surprisingly, the hydrogen storage alloy particles of the present invention has the above such constitution, whereby, when used for the negative electrode of an alkali storage battery, it is possible to reduce the dissolution of vanadium into the alkali aqueous solution over a plurality of charging and discharging cycles without causing a remarkable drop in the hydrogen storage ability.

Oxide Layer which Contains Titanium Oxide

The hydrogen storage alloy particles of the present invention have an oxide layer which contains titanium oxide on their surfaces.

In the present invention, the “oxide layer which contains titanium oxide” means, when using X-ray photoelectron spectroscopy (XPS) to analyze the composition from the surface of the hydrogen storage alloy particles toward the center, a part where peaks of titanium oxide TiO₂, that is, peaks in the ranges of a binding energy of 457 to 460 eV and 463 to 466 eV, can be confirmed.

An oxide layer which contains titanium oxide does not have to cover the entire surface of the hydrogen storage alloy particles. When using hydrogen storage alloy particles in the negative electrode of an alkali storage battery, at least part of the surface of the hydrogen storage alloy particles should be covered to an extent enabling reduction of dissolution of vanadium to the alkali aqueous solution over a plurality of charging and discharging cycles.

The lower limit of thickness of the oxide layer can be made, for example, 6.2 nm or more, 10 nm or more, 30 nm or more, or 90 nm or more, while the upper limit can be made, for example, 200 nm or less, 150 nm or less, or 100 nm or less.

Alloy Composition Etc.

The hydrogen storage alloy particles of the present invention include titanium and vanadium as main components.

In the present invention, “include titanium and vanadium as main components” means the hydrogen storage alloy particles include 25 mol % or more of titanium and 25 mol % or more of vanadium based on the alloy composition of the hydrogen storage alloy particles.

The molar ratio of titanium and vanadium can be freely set. For example, when the number of moles of titanium is “1”, the upper limit of the number of moles of vanadium can be made, for example, 3 or less or 2.5 or less and the lower limit can be made, for example, 0.5 or more, 1 or more, or 2 or more.

The hydrogen storage alloy particles may contain, in addition to titanium and vanadium, any other elements, for example, metal elements, for example alkali metal elements, alkali earth metal elements, transition metal elements, main group elements, and combinations of the same. As alkali metal elements, for example, magnesium and potassium may be mentioned. As transition metal elements, for example, chromium, manganese, iron, cobalt, nickel, copper, zirconium, niobium, etc. may be mentioned.

The hydrogen storage alloy particles may have any crystal structure, for example, body centered cubic structures (BCC structures), hexagonal closely packed structures (HCP structures), or face centered cubic structures (FCC structures).

The upper limit of the volume average size of the hydrogen storage alloy particles can be made, for example, 200 nm or less, 100 nm or less, 70 nm or less, or 50 nm or less, while the lower limit can be made, for example, 1 nm or more, 10 nm or more, 20 nm or more, or 30 nm or more.

Method of Production of Hydrogen Storage Alloy Particles

The method of the present invention for producing hydrogen storage alloy particles includes bringing hydrogen storage alloy particles which contain titanium and vanadium as main components into contact with an alkali aqueous solution to make at least part of the vanadium dissolve out from the surface of the hydrogen storage alloy particles, then making the titanium which remains at the surface of the hydrogen storage alloy particles oxidize.

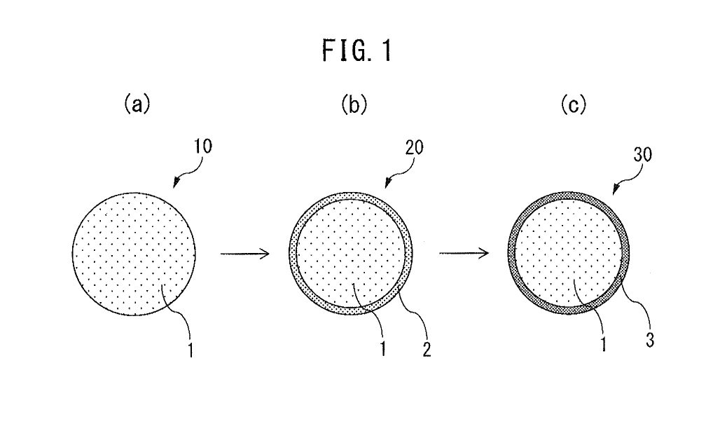

That is, as schematically shown in FIGS. 1(a) to (c), an alloy (1) which contains titanium and vanadium as main components, constituting the hydrogen storage alloy particles (10, FIG. 1a), are made to contact an alkali aqueous solution to make at least part of the vanadium dissolve out from the surface of the hydrogen storage alloy particles. Due to this, hydrogen storage alloy particles (20, FIG. 1b) which have a surface titanium layer (2) with a higher ratio of presence of titanium compared with the alloy composition used at their surface are obtained. After that, it is possible to make at least part of the titanium which remains at the surface of the hydrogen storage alloy particles, that is, the titanium which is contained at the surface titanium layer (2), oxidize so as to produce hydrogen storage alloy particles of the present invention (30, FIG. 1c) which have an oxide layer which contains titanium oxide (3) at their surfaces.

Dissolution of Vanadium

In the method of the present invention for producing hydrogen storage alloy particles, hydrogen storage alloy particles which contain titanium and vanadium as main components are made to contact the alkali aqueous solution to make at least part of the vanadium dissolve out from the surfaces of the hydrogen storage alloy particles.

In the present invention, when the ratio of presence of titanium at the surfaces of the hydrogen storage alloy particles becomes higher compared with the alloy composition used, it is possible to say that the vanadium has dissolved out.

The method of making the hydrogen storage alloy particles contact the alkali aqueous solution is not particularly limited so long as it can raise the ratio of presence of titanium at the surface of the hydrogen storage alloy particles compared with the alloy composition used. As such a method, for example, dipping hydrogen storage alloy particles which contain titanium and vanadium as main components in an alkali aqueous solution at any temperature may be mentioned.

As the alkali aqueous solution, an aqueous solution which contains a hydroxide or salt of an alkali source, for example, alkali metal or alkali earth metal may be mentioned. As the hydroxide of the alkali metal or alkali earth metal, for example potassium hydroxide, sodium hydroxide, lithium hydroxide, calcium hydroxide, and combinations of the same may be mentioned.

The temperature of the alkali aqueous solution and dipping time and other conditions may be freely set. For example, the upper limit of temperature of the alkali aqueous solution can be made, for example, 100° C. or less, 90° C. or less, or 80° C. or less, while the lower limit can be made, for example, 0° C. or more, 30° C. or more, 50° C. or more, or 60° C. or more.

The thickness of the surface titanium layer, that is, the thickness of the part where the ratio of presence of titanium becomes higher compared with the alloy composition used, can be freely set. The lower limit of the thickness of the surface titanium layer can be made, for example, 6.2 nm or more, 30 nm or more, or 90 nm or more, while the upper limit can be made, for example, 500 nm or less, 200 nm or less, or 100 nm or less.

Oxidation of Titanium

The oxidation of the titanium which is contained in the surface titanium layer, for example, can be performed by exposing the hydrogen storage alloy particles which have been made to contact the alkali aqueous solution in an atmosphere in which oxygen or another oxidizing source is present, for example, the air, at any temperature.

In oxidation of titanium, there is no need to oxidize all of the titanium which is contained in the surface titanium layer. When using the hydrogen storage alloy particles in a negative electrode of an alkali storage battery, at least part of the titanium which is contained in the surface titanium layer should be oxidized to an extent enabling reduction of dissolution of vanadium into the alkali aqueous solution over a plurality of charging and discharging cycles.

The temperature at this oxidation may be freely set to an extent where oxidation of titanium proceeds and the alloy particles do not melt together. The upper limit of temperature at this time can be made, for example, 500° C. or less, 200° C. or less, or 100° C. or less, while the lower limit can be made, for example, 30° C. or more, 50° C. or more, or 60° C. or more.

Negative Electrode

The negative electrode of the present invention has a negative electrode active component layer which contains the hydrogen storage alloy particles of the present invention on a collector.

The negative electrode of the present invention, by having such a configuration, can reduce the dissolution of vanadium to the alkali electrolyte over a plurality of charging and discharging cycles when used for an alkali storage battery.

The negative electrode active component layer contains the hydrogen storage alloy particles of the present invention. It may further contain any other additives, for example, a conductivity aid, binder, etc.

As the material of the collector, nickel, copper, aluminum, or any other metal or alloy may be mentioned. As the form of the collector, for example, a foil, nonwoven fabric, porous body, etc. may be mentioned.

As the method of production of the negative electrode of the present invention, the method of dispersing and mixing the hydrogen storage alloy particles of the present invention and any conductivity aid or other material in any dispersion medium to obtain a paste and coating and drying this on a collector to form a negative electrode active component layer on the collector may be mentioned.

As another method of production of the negative electrode of the present invention, a negative electrode active component layer which includes hydrogen storage alloy particles which contain titanium and vanadium as main components are formed on a collector. The method of making the formed negative electrode active component layer contact the alkali aqueous solution to make at least part of the vanadium dissolve out from the surfaces of the hydrogen storage alloy particles and then make the titanium which remains on the surface of the hydrogen storage alloy particles oxidize may be mentioned.

With this method, the hydrogen storage alloy particles which are present near the surface of the negative electrode active component layer have an oxide layer which contains titanium oxide. As opposed to this, the hydrogen storage alloy particles which are present inside of the negative electrode active component layer can be prevented from being given an oxide layer which contains titanium oxide. Therefore, the negative electrode of the present invention which is prepared by this method can reduce the dissolution of vanadium from the negative electrode while reducing the drop in hydrogen storage ability more effectively than the method of using hydrogen alloy particles which have oxide layers in advance so as to prepare a negative electrode.

For details of the dissolution of vanadium and oxidation of titanium after formation of the negative electrode active component layer, it is possible to adopt the explanation in the method of production of hydrogen storage alloy particles.

Alkali Storage Battery

The alkali storage battery of the present invention has the negative electrode of the present invention.

The alkali storage battery of the present invention can reduce the dissolution of vanadium to the alkali aqueous solution over a plurality of charging and discharging cycles and can maintain the battery performance for a longer period of time.

In the present invention, the “alkali storage battery” means a secondary battery which uses an electrolyte constituted by an alkali aqueous solution.

The alkali storage battery of the present invention may have a discharge cut-off voltage of 1.0V or more.

While not limited in theory, by making the discharge cut-off voltage 1.0V or more, at the time of discharge, the potential of the negative electrode less often rises over the oxidation reduction potential of vanadium and so, it is believed, the dissolution of vanadium to the alkali aqueous solution is further reduced.

Positive Electrode

As the positive electrode, it is possible to use any positive electrode so long as it can be combined with an alkali aqueous solution and the negative electrode of the present invention to form a battery. For example, a positive electrode which contains nickel hydroxide (Ni(OH)₂) or an air electrode etc. can be mentioned.

The alkali storage battery of the present invention may also be a nickel hydrogen battery which has a positive electrode which contains nickel hydroxide (Ni(OH)₂), an electrolyte constituted by an alkali aqueous solution, and a negative electrode of the present invention.

Alkali Aqueous Solution

The alkali aqueous solution is not particularly limited so long as it can be combined with any positive electrode and the negative electrode of the present invention to form a battery.

As the alkali aqueous solution, an aqueous solution which contains a hydroxide or salt of an alkali source, for example, an alkali metal or alkali earth metal may be mentioned. As the hydroxide of an alkali metal or alkali earth metal, for example, potassium hydroxide, sodium hydroxide, lithium hydroxide, calcium hydroxide, and combinations of the same may be mentioned.

### EXAMPLES

### Example

In the Example, the following Procedures 1 to 7 were used to prepare the negative electrode of the present invention. Furthermore, the Procedures 8 to 10 were used to prepare the alkali storage battery of the present invention. Note that, the following Example is for explaining the embodiments of the present invention and does not limit the scope of the present invention.

Procedure 1

Titanium (Ti, purity 99.9%, made by Kojundo Chemical Laboratory Co., Ltd.), vanadium (V, purity 99.9%, made by Kojundo Chemical Laboratory Co., Ltd.), chromium (Cr, purity 99.9%, made by Kojundo Chemical Laboratory Co., Ltd.), and nickel (Ni, purity 99.9%, made by Kojundo Chemical Laboratory Co., Ltd.) were mixed to give a molar ratio of Ti:V:Cr:Ni of, in this order, 26:56:8:10 and were made to melt by arc melting to prepare a TiVCrNi alloy.

Procedure 2

The obtained alloy was heated to 250° C. while reducing the pressure to 1 Pa or less and held there for 2 hours. The alloy was exposed to a 30 MPa hydrogen gas atmosphere, then the alloy was again reduced in pressure to 1 Pa or less.

Procedure 3

The Procedure 2 was further repeated two times.

Procedure 4

The obtained alloy was mechanically crushed and graded to obtain volume average diameter 40 nm TiVCrNi hydrogen storage alloy particles.

Procedure 5

The obtained alloy particles, a conductivity aid constituted by nickel (Ni, made by Fukuda Metal Foil & Powder Co., Ltd.), a binder constituted by carboxymethylcellulose (CMC, made by Daiichi Kogyo Co., Ltd.), and a binder constituted by polyvinyl alcohol (PVA, made by Wako Pure Chemical Industries Ltd.) were mixed to give a mass ratio of alloy particles:Ni:CMC:PVA, in that order, of 49:49:1:1 to obtain a paste-like composition. The obtained composition was coated on a collector constituted by porous nickel and dried at 80° C. and roll pressed by a pressure of 5 tons to form a negative electrode active component layer on a collector.

Procedure 6: Dissolution of Vanadium

Potassium hydroxide (KOH, made by Nacalai Tesque, INC.) and pure water were mixed to prepare a concentration 7.15 mol/liter potassium hydroxide aqueous solution. The negative electrode which was obtained in the Procedure 5 was immersed in this potassium hydroxide aqueous solution, raised in temperature to 70° C., and held at 70° C. for 1 hour. The negative electrode was taken out from the KOH aqueous solution, washed by pure water, and allowed to naturally dry.

Procedure 7: Oxidation of Titanium

The negative electrode which was obtained in the Procedure 6 was held for 24 hours in a dryer which was set to 60° C. to thereby prepare the negative electrode of the Example.

Procedure 8

Nickel hydroxide (Ni(OH)₂, made by Tanaka Chemical Corporation), cobalt oxide (CoO, made by Kojundo Chemical Laboratory Co., Ltd.), a binder constituted by carboxymethylcellulose (CMC, made by Daiichi Kogyo Co., Ltd.), and a binder constituted by polyvinyl alcohol (PVA, made by Wako Pure Chemical Industries Ltd.) were mixed to give a mass ratio of Ni(OH)₂:CoO:CMC:PVA, in that order, of 88:10:1:1, to obtain a paste-like composition. The obtained composition was coated on a collector constituted by porous nickel and dried at 80° C. and roll pressed by a pressure of 5 tons to prepare a positive electrode.

Procedure 9

Potassium hydroxide (KOH, made by Nacalai Tesque, INC.) and pure water were mixed to prepare a concentration 7.15 mol/liter electrolytic solution constituted by a potassium hydroxide aqueous solution.

Procedure 10

Inside an acrylic container, the electrolytic solution which was obtained in Procedure 9 in 90 ml, the positive electrode which was obtained in Procedure 8, and the negative electrode of the Example were inserted so that the positive electrode and the negative electrode did not contact, so as to prepare an alkali storage battery of the Example.

### Comparative Example 1

Except for not performing the Procedures 6 and 7, the same procedure was followed as in the Example to prepare the negative electrode of Comparative Example 1. Furthermore, the negative electrode of Comparative Example 1 was used to prepare an alkali storage battery of Comparative Example 1 by the Procedures 8 to 10.

### Comparative Example 2

Except for not performing the Procedure 7, the same procedure was followed as in the Example to prepare the negative electrode of Comparative Example 2. Furthermore, the negative electrode of Comparative Example 2 was used to prepare an alkali storage battery of Comparative Example 2 by the Procedures 8 to 10.

Evaluation of Amount of Dissolution of Vanadium

The following procedure was used to evaluate the amounts of dissolution of vanadium of the alkali storage batteries of the Example and Comparative Examples 1 and 2.

A discharging/charging cycle test machine VMP3 made by Bio-Logic Science Instruments SAS was used, a battery evaluation environment temperature of 25° C., a current rate of 0.1C, and a discharge cut-off voltage of 1.0V or more were set, and a discharging/charging cycle test was conducted for 10 cycles.

After the test, the alkali aqueous solution of the alkali storage battery was taken out, stirred well, then diluted by dilute sulfuric acid to obtain a dilute solution. The concentration of vanadium which is contained in the dilute solution was measured using a high-frequency inductively coupled plasma (ICP) emission spectrophotometric apparatus (made by SII Technology, SPS4000) so as to measure the amount of vanadium which was dissolved out into the alkali aqueous solution (mg/liter). The results are shown in Table 1.

TABLE 1

| | | | Amount of |
|---|---|---|---|
| | Procedure 6 | Procedure 7 | dissolution of |
| | (Dissolution of | (Oxidation of | vanadium |
| | vanadium) | titanium) | (mg/liter) |
| Example | Yes | Yes | 17 |
| Comp. Ex. 1 | None | None | 275 |
| Comp. Ex. 2 | Yes | None | 261 |

EDX and XPS Analysis

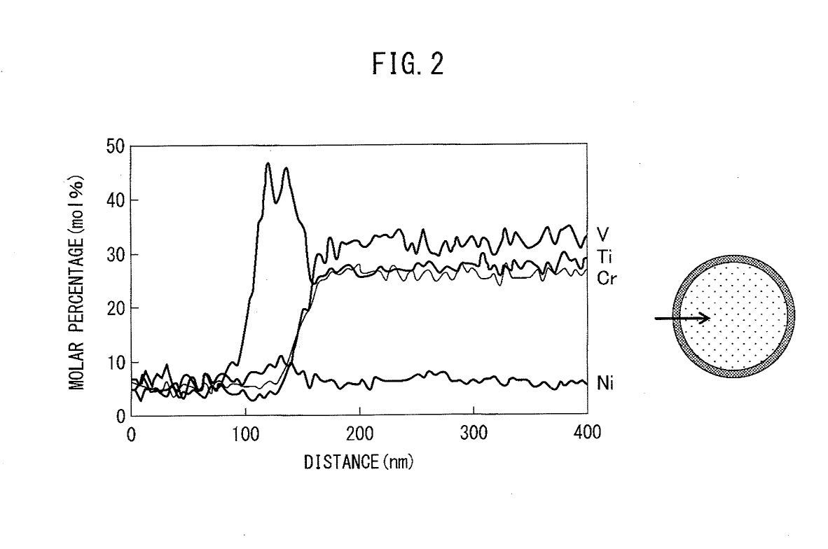

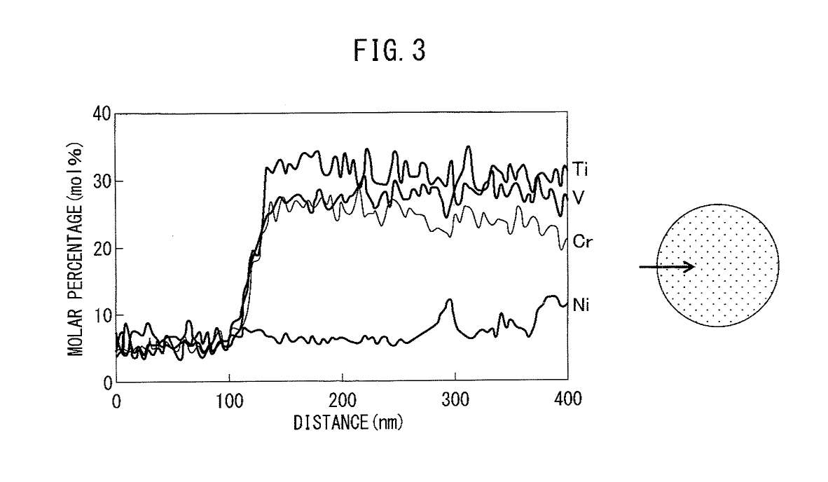

The hydrogen storage alloy particles of the negative electrodes of the Example and Comparative Example 1 were analyzed by energy dispersive X-ray spectroscopic analysis (EDX analysis) and the cross sections near the surfaces were investigated. The results of EDX analysis of the Example are shown in FIG. 2, while the results of EDX analysis of Comparative Example 1 are shown in FIG. 3. The arrows in the figures show the depth direction of analysis. Further, the molar percentages in the figures are based on the number of moles of the total atoms detected.

FIG. 2 and FIG. 3 show that the hydrogen storage alloy particles of the Example have a layer where the ratio of presence of titanium becomes higher compared with the alloy composition which is used due to the vanadium being made to dissolve out and, as opposed to this, that the hydrogen storage alloy particles of Comparative Example 1 do not have this.

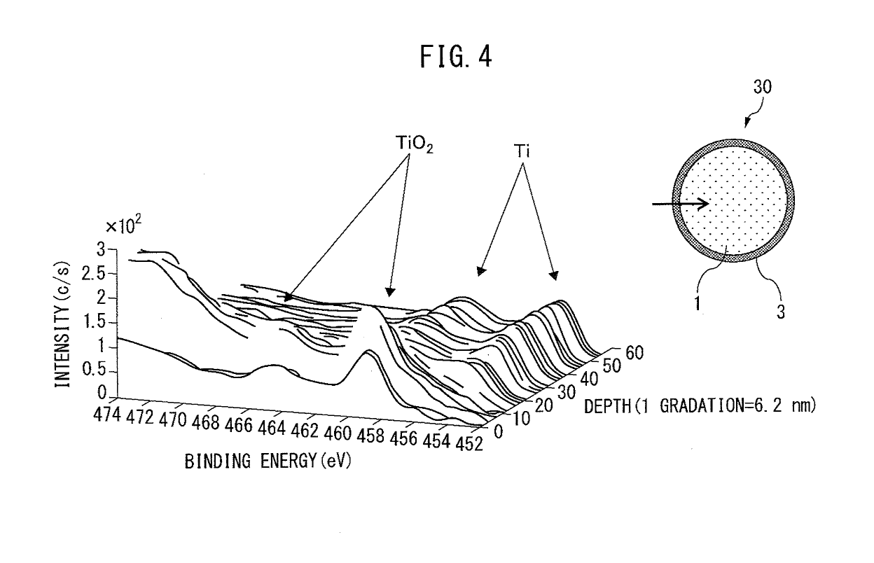

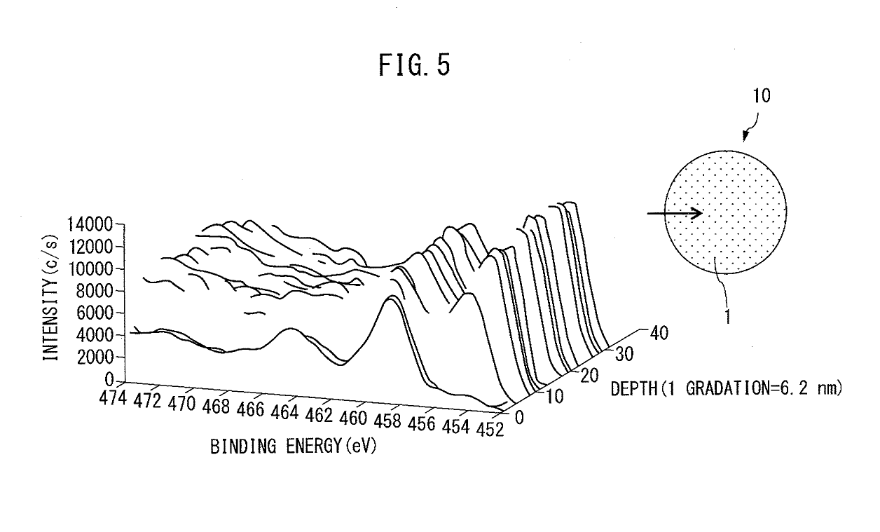

The hydrogen storage alloy particles of the negative electrodes of the Example and Comparative Example 1 were analyzed by X-ray photoelectron spectroscopic analysis (XPS analysis) and the cross-sections near the surfaces were investigated. The results of XPS analysis of the Example are shown in FIG. 4, while the results of XPS analysis of Comparative Example 1 are shown in FIG. 5. The arrows in the figures show the depth direction of analysis. The measurement was first conducted at the surface (depth=0 nm) two times, then was conducted at each 6.2 nm further in the depth direction. Therefore, in the figure, one gradation in the depth direction corresponds to the interval between measurement points of 6.2 nm.

In FIG. 4 and FIG. 5, the peaks which are present in the ranges of binding energy of 457 to 460 eV and of 463 to 466 eV show the peaks of titanium oxide (TiO₂). Further, the peaks which are present in the range of 453 to 456 eV show the peaks of non-oxidized titanium (Ti).

Referring to FIG. 4, it is possible to confirm the peaks of titanium oxide (TiO₂) at a depth of 0 nm to about 93 nm. Therefore, the hydrogen storage alloy particles of the Example have an oxide layer which contains titanium oxide at their surfaces. It is learned that this oxide layer has a thickness of about 93 nm.

As opposed to this, in the hydrogen storage alloy particles of the comparative examples, if referring to FIG. 5, the peak of titanium oxide (TiO₂) was confirmed by two measurements at the surface (depth=0 nm). However, at a 6.2 nm or more depth, no peak of titanium oxide (TiO₂) was recognized and a peak of non-oxidized titanium (Ti) was confirmed. Therefore, it is learned that a thickness of an oxide layer which contains titanium oxide at hydrogen storage alloy particles of the comparative examples is less than 6.2 nm.

From the results of FIGS. 2 to 5 and the results of evaluation of the amount of dissolution of vanadium, it was learned that the hydrogen storage alloy particles of the Example could greatly reduce the dissolution of vanadium to an alkali aqueous solution when used as a negative electrode active component of an alkali storage battery over a plurality of charging and discharging cycles compared with the hydrogen storage alloy particles of the comparative examples.

### REFERENCE SIGNS LIST

1 alloy which contains titanium and vanadium as main components
2 surface titanium layer
3 oxide layer
10 hydrogen storage alloy particles which contain titanium and vanadium as main components
20 hydrogen storage alloy particles which are brought into contact with alkali aqueous solution
30 hydrogen storage alloy particles of the present invention which have an oxide layer which contains titanium oxide on their surface

1. Hydrogen storage alloy particles which contain titanium and vanadium as main components and which have an oxide layer on their surface, said oxide layer containing titanium oxide and having a thickness of 6.2 nm or more.

2. A negative electrode which contains a negative electrode active component layer which includes hydrogen storage alloy particles according to claim 1 on a collector.

3. An alkali storage battery which has a negative electrode according to claim 2.

4. The alkali storage battery according to claim 3 wherein a discharge cut-off voltage is 1.0V or more.

5. A method of production of hydrogen storage alloy particles comprising bringing hydrogen storage alloy particles which contain titanium and vanadium as main components into contact with an alkali aqueous solution to make at least part of said vanadium dissolve out from the surface of said hydrogen storage alloy particles, then making the titanium which remains at the surface of said hydrogen storage alloy particles oxidize.

6. A method of production of a negative electrode comprising forming a negative electrode active component layer which includes hydrogen storage alloy particles which contain titanium and vanadium as main components, bringing said negative electrode active component layer into contact with an alkali aqueous solution to make at least part of said vanadium dissolve out from the surface of said hydrogen storage alloy particles, then making the titanium which remains at the surface of said hydrogen storage alloy particles oxidize.
